(19) United States
(12) Patent Application Publication
(10) Pub. No.: US 2018/0183975 A1
(43) Pub. Date: Jun. 28, 2018

(54) DATA TRANSMITTING AND RECEIVING DEVICE, AND DISPLAY APPARATUS

(71) Applicant: SAKAI DISPLAY PRODUCTS CORPORATION, Osaka (JP)

(72) Inventor: Ryusuke Horibe, Osaka (JP)

(21) Appl. No.: 15/903,223

(22) Filed: Feb. 23, 2018

Related U.S. Application Data
(63) Continuation of application No. PCT/JP2015/074087, filed on Aug. 26, 2015.

(51) Int. Cl. H04N 1/36; H04N 5/12

(52) U.S. Cl. CPC H04N 1/36; H04N 5/126

(57) ABSTRACT

A data transmitting and receiving device includes: a data transmitting circuit transmitting a clock signal and a data signal synchronized to the clock signal; and a data receiving circuit receiving the clock signal and the data signal; wherein: the data receiving circuit includes a phase error detection circuit detecting a phase error between the data signal and the clock signal; and the data transmitting circuit includes a phase adjusting circuit adjusting a phase of at least one of the clock signal and the data signal based on the phase error.

This is a continuation of International Application No. PCT/JP2015/074087, with an international filing date of Aug. 26, 2015, the entire contents of which are hereby incorporated by reference.

### BACKGROUND

### 1. Technical Field

The present invention relates to a data transmitting and receiving device and a display apparatus.

### 2. Description of the Related Art

A display apparatus including a rectangular liquid crystal panel as an image display portion is used for a TV receiver, a personal computer or the like. The display apparatus includes a timing controller and a source driver connected with the timing controller. The timing controller generates a clock signal and a data signal synchronized to the clock signal from image data, a horizontal synchronizing signal and a vertical synchronizing signal input thereto. The timing controller transmits the horizontal synchronizing signal, the clock signal and the data signal to the source driver.

The source driver receives the horizontal synchronizing signal, the clock signal and the data signal. Namely, the display apparatus includes a data transmitting and receiving device that includes the timing controller as a data transmitting circuit and includes the source driver as a data receiving circuit. The source driver synchronizes the data signal to convert the data signal to parallel data signals based on the received horizontal synchronizing signal and clock signal, and outputs the resultant parallel data signals to the liquid crystal panel.

A plurality of the source drivers are provided, and are located at a predetermined interval along longer sides of the liquid crystal panel. Therefore, in the case where the distance from the timing controller to each of the source drivers is increased as a result of enlargement of a display plane of the display apparatus, a phase error is easily caused between the clock signal and the data signal, and the transfer quality is significantly deteriorated by the influence of a resistance of a transfer path and of an impedance of a capacitance or the like. For this reason, in the case where a latch circuit for the data signal that is included in the source driver synchronizes the clock signal and the data signal to each other, it is made difficult to satisfy the setup time and the hold time.

The above-described problem is solved by adjusting the phases of the clock signal and the data signal. For example, a serial-parallel conversion device described in Japanese Laid-Open Patent Publication No. 2003-133965 includes a PLL (Phase Locked Loop) circuit that uses an oscillator to output a plurality of tap output signals having different phases from a clock signal. The serial-parallel conversion device generates a plurality of strobe signals having different phases using the tap output signals generated by the PLL circuit, and selects one of the strobe signals having an optimal timing in accordance with the phase error between a serial data signal and the clock signal.

The serial-parallel conversion device converts the serial data signal into parallel data signals by the selected strobe signal and thus adjusts the phases. Therefore, the above-described problem is solved by using the serial-parallel conversion device as the source driver.

However, in the case where the serial-parallel conversion device described in Japanese Laid-Open Patent Publication No. 2003-133965 is used as the source driver, the display apparatus needs to include a PLL circuit including an oscillator for each of the source drivers located along the longer sides of the liquid crystal panel. This enlarges the scale of the source drivers, which prevents size reduction of a frame portion of the display apparatus. The display apparatus also involves a problem that the oscillator included in the PLL circuit provided for each of the source drivers causes more unnecessary radiation and generates excessive heat. However, if no measure is taken, the problem of the deterioration of the transfer quality of the clock signal and the data signal, and the problem of the phase error between the clock signal and the data signal, remain unsolved.

### SUMMARY

One non-limiting, and exemplary embodiment provides a technique to provide a data transmitting and receiving device realizing stable data transfer and a display apparatus allowing a frame portion thereof to be reduced in size and suppressing unnecessary radiation and excessive heating.

In one general aspect, a data transmitting and receiving device disclosed herein includes a data transmitting circuit transmitting a clock signal and a data signal synchronized to the clock signal; and a data receiving circuit receiving the clock signal and the data signal. The data receiving circuit includes a phase error detection circuit detecting a phase error between the data signal and the clock signal; and the data transmitting circuit includes a phase adjusting circuit adjusting a phase of at least one of the clock signal and the data signal based on the phase error.

According to the above aspect, the phase error detection circuit detects the phase error between the clock signal and the data signal. Based on the phase error, the phase adjusting circuit adjusts the phase of at least one of the clock signal and the data signal. Therefore, the phases of the clock signal and the data signal are adjusted to be optimal. In the case where the data receiving circuit includes a latch circuit for the data signal that synchronizes the clock signal and the data signal, an optimal adjustment is performed to satisfy the setup time and the hold time of the latch circuit for the data signal included in the data receiving circuit, regardless of the distance between the data transmitting circuit and the data receiving circuit, the characteristic impedance of a transfer path or the like. Thus, stable data transfer is realized.

In the data transmitting and receiving device, the phase error detection circuit feeds phase error information regarding the detected phase error back to the data transmitting circuit.

According to the above aspect, the phase error information regarding the phase error detected by the phase error detection circuit is fed back. Based on the phase error information, the phase adjusting circuit adjusts the phases of the clock signal and the data signal.

In the data transmitting and receiving device, the data transmitting circuit transmits the clock signal and the data signal adjusted by the phase adjusting circuit to the data receiving circuit; and the data receiving circuit includes a data synchronizing circuit synchronizing the clock signal and the data signal adjusted by the phase adjusting circuit.

According to the above aspect, the data synchronizing circuit uses the clock signal and the data signal adjusted by the phase adjusting circuit to perform stable synchronization.

In one general aspect, a display apparatus disclosed herein includes the data transmitting and receiving device described above; and a liquid crystal panel including a plurality of display pixels each including a pixel electrode. The data transmitting circuit generates the data signal from image data; and the data receiving circuit writes the data signal to the pixel electrode.

According to the above aspect, the above-described data transmitting and receiving device is usable to adjust the phases of the clock signal and the data signal in an optimal manner without using a PLL circuit including an oscillator. Therefore, the display apparatus allows a frame portion thereof to be reduced in size, and suppresses unnecessary radiation and unnecessary heat generation.

According to the above aspect, it is possible to provide a data transmitting and receiving device realizing stable data transfer and a display apparatus allowing a frame portion thereof to be reduced in size and suppressing unnecessary radiation and excessive heating.

### BRIEF DESCRIPTION OF THE DRAWINGS

FIG. 1 is a block diagram showing an electric functional structure of a display apparatus in embodiment 1.

FIG. 2 is a block diagram showing a structure of a source driver and a timing controller.

FIG. 3 is a circuit diagram showing an example of structure of a phase error detection circuit.

FIG. 4A is a timing diagram showing a clock signal, a data signal, an output signal from a D flip-flop circuit, and a pulse signal from a pulse generator.

FIG. 4B is a timing diagram showing a clock signal, a data signal, an output signal from a D flip-flop circuit, and a pulse signal from a pulse generator.

FIG. 4C is a timing diagram showing a clock signal, a data signal, an output signal from a D flip-flop circuit, and a pulse signal from a pulse generator.

FIG. 5 is a circuit diagram showing a structure of a phase error detection circuit included in a display apparatus in embodiment 2.

FIG. 6 is a circuit diagram showing a structure of a phase error detection circuit included in a display apparatus in embodiment 3.

FIG. 7 is a circuit diagram showing a structure of a phase error detection circuit included in a display apparatus in embodiment 4.

### DETAILED DESCRIPTION

Hereinafter, the present invention will be described in detail with reference to the drawings showing embodiments thereof.

### Embodiment 1

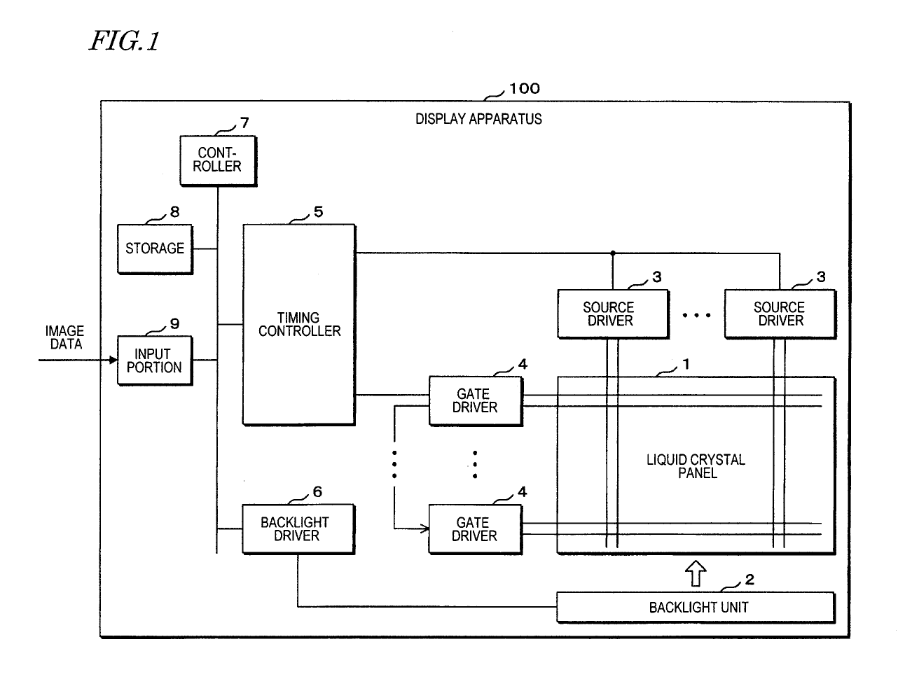

FIG. 1 is a block diagram showing an electric functional structure of a display apparatus in embodiment 1. In FIG. 1, reference sign 100 represents the display apparatus. The display apparatus 100 is usable for a TV receiver, a personal computer or the like, and displays an image.

The display apparatus 100 includes a liquid crystal panel 1 including a display plane and a backlight unit 2 irradiating the liquid crystal panel 1 with light from a surface opposite to the display plane. The liquid crystal panel 1 includes a plurality of display pixels (not shown) changing the polarization direction of light transmitted through the display pixels and switching elements (not shown) usable to write a data signal to a pixel electrode (not shown) included in each of the plurality of display pixels. The backlight unit 2 includes, for example, an LED as a light source.

The display apparatus 100 includes a plurality of source drivers 3 and a plurality of gate drivers 4 both connected to the switching elements and a timing controller 5 connected to the plurality of source drivers 3 and the plurality of gate drivers 4.

The source drivers 3 write a data signal to the pixel electrodes, and the gate drivers 4 control an operation of the switching elements. The timing controller 5 generates a start signal, a clock signal and the like that control a periodical operation of the source drivers 3 and the gate drivers 4, and transmits the generated signals to each of the source drivers 3 and each of the gate drivers 4. Namely, the display apparatus 100 includes a data transmitting and receiving device that includes the timing controller 5 as a data transmitting circuit and includes the source drivers 3 as a data receiving circuit. In the case where the signals need to be transmitted and received at high speed between the timing controller 5 and the source and gate drivers 3 and 4, a double data-rate data transfer system is used.

The display apparatus 100 further includes a backlight driver 6 connected with the backlight unit 2 to drive the backlight unit 2.

The display apparatus 100 further includes a controller 7, and a storage 8 and an input circuit 9 both connected with the controller 7. The controller 7 is also connected with the timing controller 5 and the backlight driver 6.

The controller 7 is a CPU or an MPU, and controls operations of the timing controller 5 and the backlight driver 6. The storage 8 includes a ROM, a RAM and the like, and has stored thereon a control program necessary for an operation of the controller 7. Image data, a horizontal synchronizing signal and a vertical synchronizing signal are input to the input circuit 9 from the outside of the display apparatus 100.

The controller 7 reads and executes the control program stored on the storage 8 to perform various processes, and temporarily stores data generated during a computation step of such a process on the storage

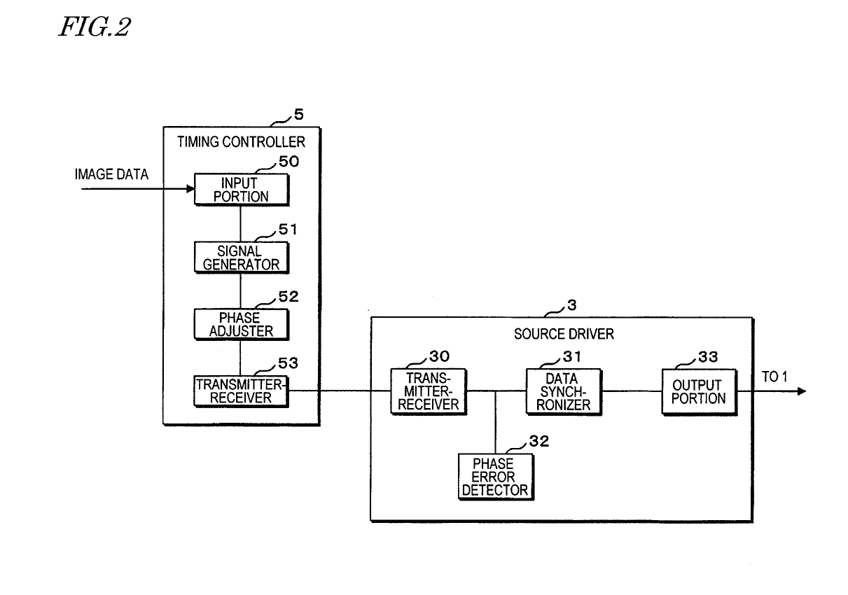

FIG. 2 is a block diagram showing a structure of the source drivers 3 and the timing controller 5. FIG. 2 shows one source driver 3, but the other source drivers 3 have substantially the same structure. The source drivers 3 are each connected with the timing controller 5.

The timing controller 5 includes an input circuit 50, a signal generator 51 connected with the input circuit 50, a phase adjusting circuit 52 connected with the signal generator 51, and a transmitting-receiving circuit 53 connected with the phase adjusting circuit 52.

Image data, a horizontal synchronizing signal and a vertical synchronizing signal are input to the signal generator 51 via the input circuit 50. The signal generator generates a clock signal and a serial data signal synchronized to the clock signal based on the image data, the horizontal synchronizing signal and the vertical synchronizing signal input thereto, and inputs the generated signals to the phase adjusting circuit 52.

Based on phase error information described below, the phase adjusting circuit 52 adjusts the phase of either one of the clock signal and the data signal input from the signal generator 51. The phase adjusting circuit 52 transmits the clock signal, the serial data signal and the horizontal synchronizing signal to the source driver 3 via the transmitting-receiving circuit 53.

The source driver 3 includes a transmitting-receiving circuit 30 both connected with the transmitting-receiving circuit 53 of the timing controller 50, a data synchronizing circuit 31 and a phase error detection circuit 32 connected with the transmitting-receiving circuit 30, and an output circuit 33 connected with the data synchronizing circuit 31.

The source driver 3 receives the clock signal, the data signal and the horizontal synchronizing signal transmitted from the timing controller 5 by the transmitting-receiving circuit 30. The clock signal and the data signal are input to the data synchronizing circuit 31 and the phase error detection circuit 32. The horizontal synchronizing signal is input to the data synchronizing circuit 31.

The data synchronizing circuit 31 includes a plurality of latch circuits (not shown). The data synchronizing circuit 31 synchronizes the serial data signal based on the clock signal and the horizontal synchronizing signal to convert the serial data signal into parallel data signals. The data synchronizing circuit 31 outputs the resultant parallel data signals to the liquid crystal panel 1 via the output circuit 33. The phase error detection circuit 32 detects a phase error between the data signal and the clock signal, and transmits phase error information regarding the detected phase error to the timing controller 5 via the transmitting-receiving circuit 30.

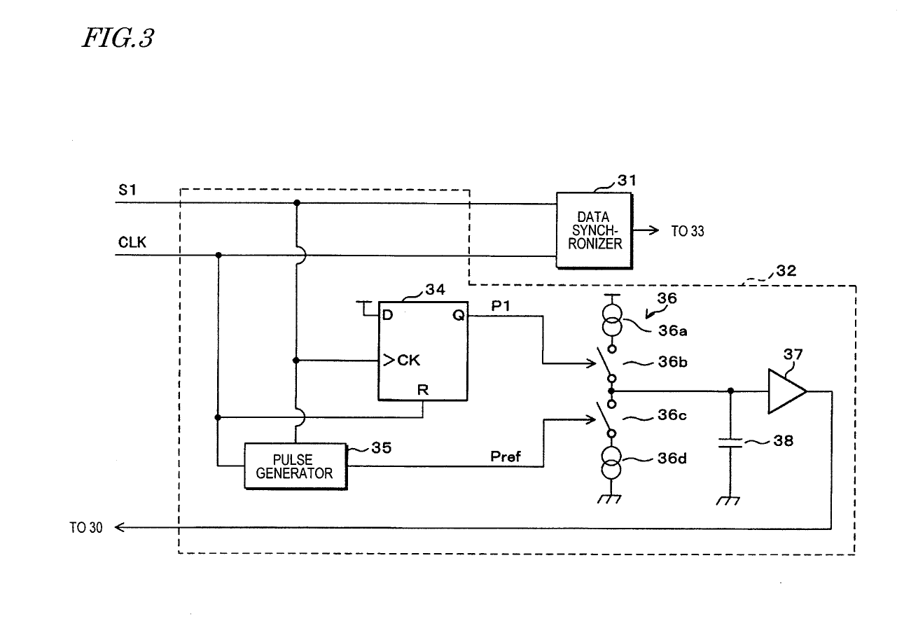

FIG. 3 is a circuit diagram showing an example of structure of the phase error detection circuit 32. The phase error detection circuit 32 includes a D flip-flop circuit 34, a pulse generator 35, and a charge pump circuit 36 connected with an output terminal of the D flip-flop circuit 34 and with the pulse generator 35. The phase error detection circuit 32 further includes a buffer 37 connected with the charge pump circuit 36, and a capacitor 38 having one end connected between the charge pump circuit 36 and the buffer 37 and the other end grounded.

The D flip-flop circuit 34 is operated at both of two input edges thereof, namely, at a CK terminal and an R terminal. In the D flip-flop circuit 34, a data signal is input to the CK terminal, and a clock signal is input td the R terminal. A D terminal is fixed to high level. When a data signal having a level change edge is input to the D flip-flop circuit 34, a Q output changes from low level to high level. When, after this, a clock signal having a level change edge is input to the D flip-flop circuit 34, the Q output changes from high level to low level. The Q output is input to the charge pump circuit 36.

A clock signal and a data signal are input to the pulse generator 35. The pulse generator 35 generates a pulse signal having a high level period of a width that is ¼ of the period of the clock signal. Such a pulse signal changes from low level to high level at the level change edge of the data signal, and after an elapse of the width of ¼ of the period of the clock signal, changes from high level to low level. The pulse signal is input to the charge pump circuit 36.

The charge pump circuit 36 includes a constant current source 36a, switching elements 36b and 36c, and a constant current source 36d connected in series from a power supply to the ground. A connection point between the switching elements 36b and 36c is connected with the buffer 37.

In the case where the signal input from the D flip-flop circuit 34 is of high level, the switching element 36b is turned on. In the case where the signal input from the D flip-flop circuit 34 is of low level, the switching element 36b is turned off. When the switching element 36b is turned on, a constant current I flows from the charge pump circuit 36 to the capacitor 38.

In the case where the signal input from the pulse generator 35 is of high level, the switching element 36c is turned on. In the case where the signal input from the pulse generator 35 is of low level, the switching element 360 is turned off. When the switching element 36c is turned on, a constant current I flows from the capacitor 38 to the charge pump circuit 36.

Therefore, in the case where only the switching element 36b is on, the voltage of the capacitor 38 is increased. In the case where only the switching element 36c is on, the voltage of the capacitor 38 is decreased. In the case where both of the switching elements 36b and 36c are on or off, the voltage of the capacitor 38 is kept the same.

The buffer 37 performs impedance conversion of the voltage of the capacitor 38 and outputs the resultant voltage. The voltage output from the buffer 37 is transmitted as analog phase error information to the phase adjusting circuit 52 of the timing controller 50 via the transmitting-receiving circuit 30.

Hereinafter, an operation of the display apparatus 100 having the above-described structure will be described. When image data is input, together with a horizontal synchronizing signal and a vertical synchronizing signal, to the display apparatus 100 via the input circuit 9 from a personal computer, a TV receiver or the like, the controller 7 reads the control program from the storage 8 and performs an operation for image display.

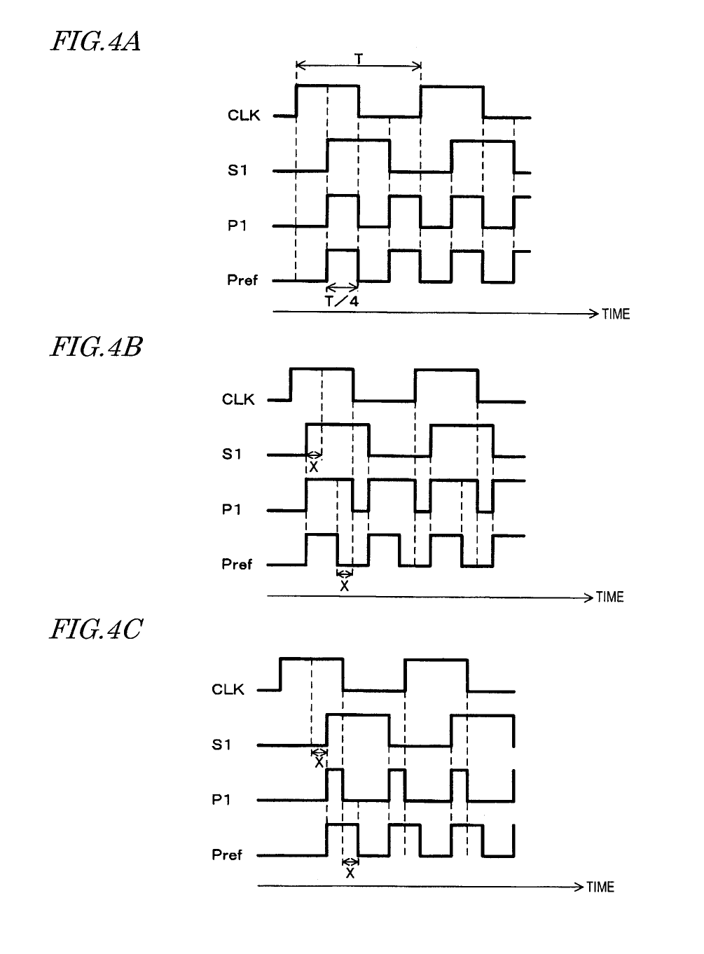

FIG. 4A, FIG. 4B and FIG. 4C are each a timing diagram showing a clock signal CLK, a data signal S1, an output signal P1 (hereinafter, referred to as “a phase error pulse signal P1”) from the D flip-flop circuit 34, and a pulse signal Pref (hereinafter, referred to as “a a reference phase error pulse signal Pref”) generated by the pulse generator 35. FIG. 4A shows a case where the phases of the clock signal CLK and the data signal S1 are adequate without being shifted from each other. FIG. 4B shows a case where the phase of the data signal S1 is advanced with respect to the phase of the clock signal CLK. FIG. 4B shows a case where the phase of the data signal S1 is delayed with respect to the phase of the clock signal CLK.

The controller 7 inputs the image data, the horizontal synchronizing signal, the vertical synchronizing signal and the like to the signal generator 51 of the timing controller 5. Based on the input image data, horizontal synchronizing signal, vertical synchronizing signal and the like, the signal generator 51 generates the clock signal CLK, which has a period T, and the data signal S1 synchronized to the clock signal CLK as shown in FIG. 4. The data signal S1 generated by the signal generator 51 is serial. The data signal S1 has the level thereof changed at the timing of the center between the rise and the fall of the clock signal CLK, so as to maximize the margin for the setup time and the hold time in the data synchronizing circuit 31. The signal generator 51 inputs the clock signal CLK and the data signal S1 generated by the signal generator 51, the horizontal synchronizing signal and the like to the phase adjusting circuit 52. The signal generator 51 also generates a clock signal and the like for the gate driver 4 and transmits the generated clock signal and the like to the gate driver 4 together with the horizontal synchronizing signal and the vertical synchronizing signal.

The source driver 3 receives the clock signal CLK, the data signal S1 and the horizontal synchronizing signal by the transmitting-receiving circuit 30. The clock signal CLK, the data signal S1, the horizontal synchronizing signal and the like are input to the data synchronizing circuit 31, and the clock signal CLK and the data signal S1 are input to the phase error detection circuit 32. Based on the input clock signal CLK and horizontal synchronizing signal, the data synchronizing circuit 31 synchronizes the serial data signal S1 to convert the serial data signal S1 into parallel data signals, and outputs the parallel data signals to the liquid crystal panel 1 via the output circuit 33. The gate driver 4 generates a gate signal using the clock signal CLK, the horizontal synchronizing signal and the vertical synchronizing signal, and outputs the generated gate signal to the liquid crystal panel 1.

The clock signal CLK and the data signal S1 received by the phase error detection circuit 32 are input to the D flip-flop circuit 34 and the pulse generator 35. While the clock signal CLK and the data signal S1 are transmitted and received, the phases of the clock signal CLK and the data signal S1 may be shifted from each other due to the distance between the timing controller 5 and the source driver 3, impedance variance of the data transfer path or the like.

As shown in FIG. 4A, FIG. 4B and FIG. 4C, the D flip-flop circuit 34 outputs a phase error pulse signal P1 regarding the phase error between the data signal S1 and the clock signal CLK. As shown in FIG. 4A, FIG. 4B and FIG. 4C, the pulse generator 35 outputs a reference phase error pulse signal Pref having a high level period of T/4.

Regardless of whether the phase of the data signal S1 is advanced or delayed with respect to the clock signal CLK, the phase error pulse signal P1 and the reference phase error pulse signal Pref rise at the same time. As shown in FIG. 4B, in the case where the phase of the data signal S1 is advanced by X with respect to the phase of the clock signal CLK, the phase error pulse signal P1 falls with a delay of X with respect to the reference phase error pulse signal Pref. As shown in FIG. 4C, in the case where the phase of the data signal S1 is delayed by X with respect to the phase of the clock signal CLK, the phase error pulse signal P1 falls with an advance of X with respect to the reference phase error pulse signal Pref. Thus, a phase shift of the clock signal CLK or the data signal S1 from an adequate phase, namely, the phase error, is represented as a difference between the periods in which the phase error pulse signal P1 and the reference phase error pulse signal Pref are of high level.

The phase error pulse signal P1 is input to the switching element 36b, and when being of high level, turns on the switching element 36b and causes the constant current I to flow to the capacitor 38. The reference phase error pulse signal Pref is input to the switching element 36c, and when being of high level, turns on the switching element 36c and absorbs the constant current I from the capacitor 38.

In the case where the phase of the data signal S1 is advanced by the phase of the clock signal CLK, the period in which the phase error pulse signal P1 is of high level is longer than the period in which the reference phase error pulse signal Pref is of high level. Therefore, there occurs a period in which only the switching element 36b is on. In this case, the voltage of the capacitor 38 is increased, and the output voltage of the buffer 37 is increased.

By contrast, in the case where the phase of the data signal S1 is delayed by the phase of the clock signal CLK, the period in which the phase error pulse signal P1 is of high level is shorter than the period in which the reference phase error pulse signal Pref is of high level. Therefore, there occurs a period in which only the switching element 36c is on. In this case, the voltage of the capacitor 38 is decreased, and the output voltage of the buffer 37 is decreased.

The phase error detection circuit 32 converts the phase error between the clock signal CLK and the data signal S1 into an analog voltage signal, and transmits the analog voltage signal as analog phase error information to the phase adjusting circuit 52. Namely, the phase error detection circuit 32 feeds the phase error information back to the timing controller 5. In this step, it is preferred that the phase error detection circuit 32 transmits a reference voltage signal (VREF) to the phase adjusting circuit 52 together with the analog signal regarding the phase error. It is preferred that the reference voltage signal is of, for example, a constant voltage that is ½ of the supply voltage of the charge pump circuit 36. The phase adjusting circuit 52 adjusts the phase based on a differential voltage between the analog signal regarding the phase error received via the transmitting-receiving circuit 53 and the reference voltage signal. As a result, an analog signal error caused by an offset voltage, electric field noise or the like caused during the transfer of the analog signal is more suppressed than in the case where only the analog signal regarding the phase error is transmitted and received as the phase error information.

The phase adjusting circuit 52 delays at least one of the phase of the data signal S1 and the phase of the clock signal CLK such that the phase error between the data signal S1 and the clock signal CLK is a predetermined value, for example, zero, to perform phase adjustment. The phase adjusting circuit 52 transmits the adjusted data signal S1 and clock signal CLK to the source driver 3 via the transmitting-receiving circuit 53.

The source driver 3 may convert the analog voltage signal regarding the phase error information into an analog current and transmit the analog current to the phase adjusting circuit 52. In the case where the phase error information is transferred as a current, an offset of the phase error information caused by the electric field noise during the transfer of the analog signal from the source driver 3 to the timing controller 5, and the influence of the noise, are suppressed.

The gate driver 4 drives a switching element in a corresponding display pixel in the liquid crystal panel 1 by a gate signal, and the source driver 3 writes the parallel data signals S1, having the phase thereof adjusted by the above-described driving, to a pixel electrode in the corresponding display pixel in the liquid crystal panel 1. The controller 7 drives the backlight driver 6 to irradiate the liquid crystal panel 1 with light from the backlight unit from the surface opposite to the display plane. The display apparatus 100 causes the liquid crystal panel 1 to change the polarization direction of the light from the backlight unit 2, and displays an image, corresponding to the image data input to the display apparatus 100, on the display plane of the liquid crystal panel 1.

With the above-described structure, the phase error detection circuit 32 detects the phase error between the clock signal and the data signal received by the source driver 3, and transmits the phase error information as an analog signal to the phase adjusting circuit 52. Based on the phase error information, the phase adjusting circuit 52 of the timing controller 5 makes an adjustment such that the clock signal and the data signal are always in optimal phases. Therefore, the setup time and the hold time of the latch circuits for the data signal in the data synchronizing circuit 31 are satisfied and thus stable data transfer is realized, regardless of the distance between the timing controller 5 and the source driver 3, impedance variance of the data transfer path, delay due to the temperature characteristics or the like.

The phase error detection circuit 32 feeds the phase error information back to the timing controller 5. This allows the phase adjusting circuit 52 to adjust the phases of the clock signal and the data signal based on the phase error information. The data synchronizing circuit 31 performs synchronization stably by use of the clock signal and the data signal adjusted by the phase adjusting circuit 52.

The phase error information is output as an analog signal. In this case, as compared with the case where the phase error information is output as a digital signal, a simpler circuit is usable to output the phase error information. In addition, the display apparatus 100 does not need to include an oscillator in the source driver 3. Therefore, the frame portion is reduced in size, and unnecessary radiation and unnecessary heat generation are suppressed.

The phase error information may be transmitted to the phase adjusting circuit 52 after being converted into a digital signal by an analog-digital converter. The digital signal may be parallel or serial.

### Embodiment 2

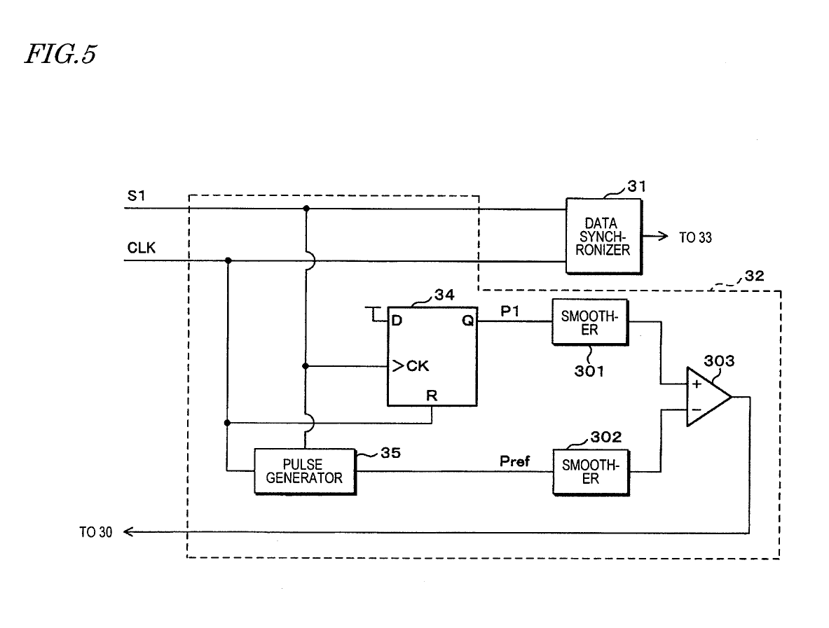

FIG. 5 is a circuit diagram showing a structure of a phase error detection circuit 32 included in a display apparatus 100 in embodiment 2. Regarding the structure of the display apparatus 100 in embodiment 2, components that are substantially the same as those in embodiment 1 will bear the same reference signs and detailed descriptions thereof will be omitted.

The phase error detection circuit 32 included in the display apparatus 100 in embodiment 2 includes smoothing circuits 301 and 302 and a computation circuit 303 instead of the charge pump circuit 36, the buffer 37 and the capacitor 38.

The smoothing circuits 301 and 302 are each a low pass filter that cut noise of a pulse frequency component. The smoothing circuit 301 is connected with the output terminal of the D flip-flop circuit 34, and the smoothing circuit 302 is connected with the pulse generator 35.

The computation circuit 303 is a subtraction circuit, and includes a plus-side input terminal connected with the smoothing circuit 301, and a minus-side input terminal connected with the smoothing circuit 302. An output terminal of the computation circuit 303 is connected with the transmitting-receiving circuit 30. The computation circuit 303 calculates a difference between the output from the smoothing circuit 301 and the output from the smoothing circuit 302, and outputs the obtained difference as phase error information. The phase error detection circuit 32 detects the computation result provided by the computation circuit 303 as an analog voltage signal representing a phase error between the data signal S1 and the clock signal CLK, and transmits the analog voltage signal to the phase adjusting circuit 52 as the phase error information. Namely, the phase error detection circuit 32 feeds the phase error information back to the timing controller 5, namely, the data transmitting circuit.

The phase adjusting circuit 52 delays at least one of the phase of the data signal S1 and the phase of the clock signal CLK such that the phase error between the data signal S1 and the clock signal CLK is a predetermined value, for example, zero, to perform phase adjustment. The phase adjusting circuit 52 transmits the adjusted data signal S1 and clock signal CLK to the source driver 3 via the transmitting-receiving circuit 53.

The source driver 3 may convert the analog voltage signal regarding the phase error information into an analog current and transmit the analog current to the phase adjusting circuit 52. In the case where the phase error information is transferred as a current, an offset of the phase error information caused by the electric field noise during the transfer of the analog signal from the source driver 3 to the timing controller 5, and the influence of the noise, are suppressed.

The phase error information may be transmitted to the phase adjusting circuit 52 after being converted into a digital signal.

### Embodiment 3

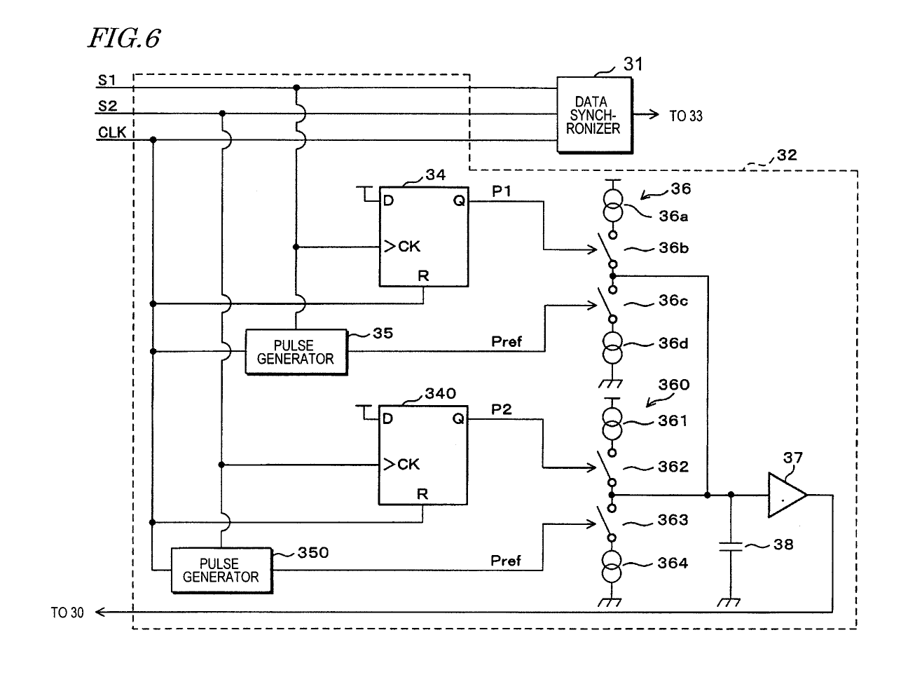

FIG. 6 is a circuit diagram showing a structure of a phase error detection circuit 32 included in a display apparatus 100 in embodiment 3. In embodiment 3, a structure for a case where a plurality of data signals Sx are present for one clock signal CLK will be described. Regarding the structure of the display apparatus 100 in embodiment 3, components that are substantially the same as those in embodiment 1 will bear the same reference signs and detailed descriptions thereof will be omitted.

In the display apparatus 100 in embodiment 3, the signal generator 51 generates a data signal S2 in addition to the data signal S1. The data signal S1 and the data signal S2 are generated in the same manner and included in the data signals Sx. The data signals S1 and S2 are written to a display pixel in the liquid crystal panel 1, and thus an image is displayed on the display plane of the liquid crystal panel 1.

The phase error detection circuit 32 includes, in addition to the components in embodiment 1, a D flip-flop circuit 340, a pulse generator 350 and a charge pump circuit 360. The D flip-flop circuit 340 and the pulse generator 350 respectively have substantially the same structures as those of the D flip-flop circuit 34 and the pulse generator 35. The charge pump circuit 360 has substantially the same structure as that of the charge pump circuit 36, and includes a constant current source 361, switching elements 362 and 363, and a constant current source 364 connected in series from a power supply to the ground. A connection point between the switching elements 362 and 363 is connected with the buffer 37.

The data signal S2 is input to a CK terminal of the D flip-flop circuit 340, and the clock signal CLK is input to an R terminal of the D flip-flop circuit 340. Like the D flip-flop circuit 34, the D flip-flop circuit 340 outputs a phase error pulse signal P2 regarding a phase error between the data signal S2 and the clock signal CLK.

The data signal S2 and the clock signal CLK are input to the pulse generator 350. The pulse generator 350 outputs a reference phase error pulse signal Pref having a high level period of T/4.

In the case where the phase of the data signal S2 is advanced by the phase of the clock signal CLK, a constant current I flows from the charge pump circuit 360, like from the charge pump circuit 36, to the capacitor 38. As a result, the voltage of the capacitor 38 is increased, and the output voltage of the buffer 37 is increased.

By contrast, in the case where the phase of the data signal S2 is delayed by the phase of the clock signal CLK, the constant current I flows from the capacitor 38 to the charge pump circuit 360. The voltage of the capacitor 38 is decreased, and the output voltage of the buffer 37 is decreased.

The voltage of the capacitor 38 corresponds to an average phase error between the data signals S1 and S2 and the clock signal CLK, and the buffer 37 outputs the voltage of the capacitor 38 as the phase error information. In this manner, even in the case where there are a plurality of data signals, the display apparatus 100 adjusts the phases of the data signals and the clock signal in a preferred manner.

In the case where, for example, there is a skew between the data signal S1 and the data signal S2, if the phases of the data signal S1 and the clock signal CLK are adjusted optimally, the phases of the data signal S2 and the clock signal CLK may be shifted from the optimal phases. However, with the above-described structure, the phases of the data signal S1 and the clock signal CLK, and the phases of the data signal S2 and the clock signal CLK, are evenly adjusted to be optimal.

The number of the data signals Sx is not limited to two, and may be three or greater. In such a case, a D flip-flop circuit, a pulse generator and a charge pump circuit may be connected with each other for each data signal, and the charge pump circuits may each be connected with the buffer 37.

### Embodiment 4

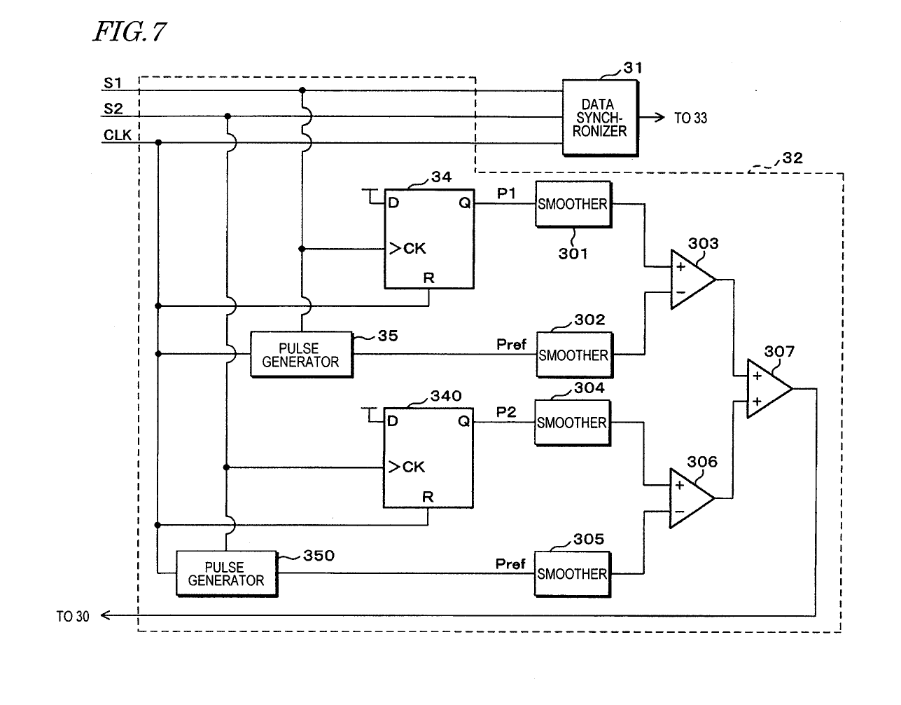

FIG. 7 is a circuit diagram showing a structure of a phase error detection circuit 32 included in a display apparatus 100 in embodiment 4. In embodiment 4, like in embodiment 3, a structure for a case where a plurality of data signals Sx are present for one clock signal CLK will be described. Regarding the structure of the display apparatus 100 in embodiment 4, components that are substantially the same as those in embodiment 1 will bear the same reference signs and detailed descriptions thereof will be omitted.

In the display apparatus 100 in embodiment 4, the phase error detection circuit 32 includes the D flip-flop circuit 34 and the pulse generator 35 like in embodiment 1. The phase error detection circuit 32 includes the smoothing circuits 301 and 302 and the computation circuit 303 like in embodiment 2. The phase error detection circuit 32 includes the D flip-flop circuit 340 and the pulse generator 350, and the signal generator 51 generates the data signals S1 and S2 as the data signals Sx, like in embodiment 3.

Unlike in embodiments 1 through 3, the phase error detection circuit 32 further includes smoothing circuits 304 and 305 and a computation circuit 306. The smoothing circuits 304 and 305 and the computation circuit 306 respectively have substantially the same structures as those of the smoothing circuits 301 and 302 and the computation circuit 303. The smoothing circuit 304 is connected with an output terminal of the D flip-flop circuit 340 and also with a plus-side input terminal of the computation circuit 306. The smoothing circuit 305 is connected with the pulse generator 350 and also with a minus-side input terminal of the computation circuit 306.

The phase error detection circuit 32 further includes a computation circuit 307. The computation circuit 307 is an addition circuit, and outputs a sum of two input values. A computation result output from each of the computation circuits 303 and 306 is input to the computation circuit 307. The computation circuit 307 outputs a computation result thereof as phase error information.

With the above-described structure, even in the case where there are a plurality of data signals, the display apparatus 100 adjusts the phases of the data signals and the clock signal in a preferred manner.

The number of the data signals Sx is not limited to two, and may be three or greater. In such a case, a smoothing circuit and a subtraction circuit may be connected with each other for each data signal, and the subtraction circuits may each be connected with the computation circuit 307.

The embodiments disclosed herein are examples in all the aspects and are not to be construed as being limiting. The scope of the present invention is defined by the claims, not by the above-described significance, and encompasses all the significance equivalent to the claims and all the alterations in the claim scope. Namely, embodiments obtained as a result of combining the technological features optionally altered in the scope of the claims are encompassed in the technological scope of the present invention.

What is claimed is:

1. A data transmitting and receiving device, comprising:
a data transmitting circuit transmitting a clock signal and a data signal synchronized to the clock signal; and
a data receiving circuit receiving the clock signal and the data signal;
wherein:
the data receiving circuit includes a phase error detection circuit detecting a phase error between the data signal and the clock signal; and
the data transmitting circuit includes a phase adjusting circuit adjusting a phase of at least one of the clock signal and the data signal based on the phase error.

2. The data transmitting and receiving device according to claim 1, wherein the phase error detection circuit feeds phase error information regarding the detected phase error back to the data transmitting circuit.

3. The data transmitting and receiving device according to claim 1, wherein:
the data transmitting circuit transmits the clock signal and the data signal adjusted by the phase adjusting circuit to the data receiving circuit; and
the data receiving circuit includes a data synchronizing circuit synchronizing the clock signal and the data signal adjusted by the phase adjusting circuit.

4. A display apparatus, comprising:
the data transmitting and receiving device according to claim 1; and
a liquid crystal panel including a plurality of display pixels each including a pixel electrode;
wherein:
the data transmitting circuit generates the data signal from image data; and
the data receiving circuit writes the data signal to the pixel electrode.
